(19) United States
(12) Patent Application Publication
(10) Pub. No.: US 2020/0065720 A1
(43) Pub. Date: Feb. 27, 2020

(54) INFORMATION PROCESSING APPARATUS, CONTROL METHOD FOR INFORMATION PROCESSING APPARATUS, AND PROGRAM

(71) Applicant: GURUNAVI, INC., Tokyo (JP)

(72) Inventor: Shinji KOKI, Tokyo (JP)

(73) Assignee: GURUNAVI, INC., Tokyo (JP)

(21) Appl. No.: 16/462,815

(22) PCT Filed: Nov. 24, 2017
(86) PCT No.: PCT/JP2017/042281

§ 371 Date: May 21, 2019

(30) Foreign Application Priority Data
Nov. 25, 2016 (JP) 2016-229126

(51) Int. Cl. G06Q 10/02; G06Q 50/12

(52) U.S. Cl. CPC G06Q 10/02; G06Q 50/12

(57) ABSTRACT

To perform appropriate seat assignment in accordance with a reservation reception state in an information processing device that receives a reservation.

A storage unit stores information on a first table group which is ordered and a second table group which is used in a case where there is no room for the first table group. The control unit associates received reservation information with tables of the first table group in order from a higher-order table on the basis of the reservation information, when the reservation information is received. In a case where the first table group does not include a table associated with the reservation information, the control unit cancels the association of a plurality of pieces of existing reservation information, and calculates a degree of priority on the basis of the reservation information. In addition, the control unit adds at least one table selected from the second table group to the first table group, and then associates the reservation information with the first table group on the basis of the calculated degree of priority.

### BACKGROUND OF THE INVENTION

### 1. Field of the Invention

The present disclosure relates to an information processing device, a control method thereof, and a program.

### 2. Description of Related Art

An example of the related art of an information system that reserves the reception of a food providing service provided by a restaurant or the like is a technique disclosed in PTL 1. PTL 1 discloses a technique for receiving a facility use reservation including information, such as the number of persons and a store visit time, together with user identification information from a portable communication terminal to confirm a vacant seat and make a reservation.

### CITATION LIST

### Patent Literature

PTL 1: Japanese Unexamined Patent Application Publication No. 2015-153403

### SUMMARY OF THE INVENTION

According to the technique disclosed in PTL 1, a user can simply make a reservation at a certain store having a vacant seat, but it is not possible to even guide a user to an appropriate table (table) on the store side.

The guidance of a user to an appropriate table essentially requires skill and know-how. A user visiting a store which is a restaurant prefers as wide a table as possible, and prefers a quiet table which is distant from a door, a passage to a kitchen, or the like. Response to the user's desire leads to customer satisfaction, but an increase in the number of visiting customers also results in the necessity of guidance to a table having poor conditions. An usher in a store needs to switch from a seat assignment method of “first-come-first-served to seat having good conditions” for guiding a user from a comfortable seat in order to a seat assignment method of “seat assignment efficiency priority” for providing services to as many users as possible, in accordance with the degree of congestion of the store.

In a case where it is considered that seat assignment can be performed in a reservation system of a restaurant in which a server computer, a client terminal, and the like are combined with each other, it is necessary to technically solve the above-described problem of switching from “first-come-first-served to seat having good conditions” to “seat assignment efficiency priority” in accordance with the degree of congestion of a store.

In stores, tables for guidance may be classified in accordance with the size of a group of store visit customers. For example, a table group for a group constituted by four to six persons and a table group for a group constituted by two to four persons are prepared, and tables for guidance are assigned in accordance with the size of a group. However, in a case where there is an attempt to execute this operation in accordance with a seat assignment algorithm in the above-described reservation system, a latter-visiting group may be guided to a better seat than a former-visiting group, which results in a possibility of unfairness.

Specifically, for example, as a result of the guidance of a two-person group based on the method of “first-come-first-served to seat having good conditions”, table groups for a group of two to four persons are out of stock, and thus a situation may occur in which a two-person group visiting next is guided or has to be guided to a table belonging a table group for a group of up to four to six persons which has a larger capacity (that is, has better conditions) than a table group for a group of up to two to four persons. From such a viewpoint, there is a demand for switching from “first-come-first-served to seat having good conditions” to “seat assignment efficiency priority” in accordance with the degree of congestion of a store.

In view of the above-described situation, an object of this technique is to perform appropriate seat assignment in accordance with a reservation reception state in an information processing device that receives a reservation.

An information processing device as an aspect of the invention for accomplishing the object is an information processing device that receives a reservation of a service to be provided to one or more persons at a table, and includes a reception unit, a storage unit, a control unit, and an output unit.

The reception unit receives reservation information for reserving reception of the service to be provided to a group including one or more persons.

The storage unit stores information on a first table group which is used for the provision of the service and is ordered, and on a second table group which is used for the provision of the service in a case where there is no room for the first table group and is constituted by tables having higher orders than tables belonging to the first table group.

The control unit associates the reservation information with the tables of the first table group in order from the higher-order table as long as one-to-one association with the tables belonging to the first table group is capable of being performed, when the reservation information is received by the reception unit.

In addition, the control unit cancels association of a plurality of pieces of existing reservation information in a case where the first table group does not include a table associated with the reservation information.

In addition, the control unit calculates a degree of priority for providing the service to the group for which the reservation information is reserved, with respect to each of the received plurality of pieces of reservation information, on the basis of the reservation information.

In addition, the control unit adds at least one table selected from the second table group to the first table group, and then associates the reservation information with the tables of the first table group in order from the higher-order table on a one-to-one basis, on the basis of the calculated degrees of priority.

The output unit that outputs information on the table associated with the reservation information, together with the reservation information.

According to the information processing device, a customer group is associated with the table belonging to the first table group in order of reservations during the association (during a relatively slack hour in a store), and thus the customer group can be guided to a wide and good seat on a first-come-first-served basis. On the other hand, when association with the table belonging to the first table group is not performed (when a large number of reservations are made), association is performed on the basis of the degree of priority of the customer group after adding reserve tables (seats which are originally desired to be kept for a larger number of customers, or the like) to the first table group, and thus it is possible to perform seat assignment by giving priority to seat efficiency.

In addition, it is possible to prevent wide seats capable of dealing with a large number of customers from being assigned to a group who makes a reservation afterward. Thereby, it is possible to reduce the possibility of unfairness to be given to a customer.

In addition, the information processing device including the control unit can collectively perform seat assignment processes which have been separately performed in a plurality of stores in the related art. Accordingly, each of the plurality of stores does not need to be provided with a high-performance computer, which also results in an effect of saving computer resources.

The control unit may calculate the degree of priority included in the reservation information, on the basis of at least one or more selected from the number of persons, a customer unit price, reservation time, a staying time, and a past service use mode which are acquired from the reservation information.

The control unit calculates the degree of priority in this manner, and thus the history of a user who brought sales to the store in the past is considered, and it is possible to increase the degree of satisfaction of both the store and the user.

The control unit may determine full occupancy in a case where the reception unit receives the reservation information of a group having the same number of tables as the number of tables obtained by adding the number of tables of the first table group and the number of tables of the second table group.

The control unit determines full occupancy in this manner, and thus it is possible to provide an upper limit in the reception of a reservation and to increase the degree of satisfaction of both the store and the user.

The storage unit may store a plurality of pieces of information on the first table group and the second table group, and the reception unit may receive the reservation information including the number of persons of the group.

In this case, the control unit may select any one information from among the plurality of pieces of information on the first table group and the second table in accordance with the number of persons included in the reservation information received by the reception unit, and associates the received reservation information with any one table of the first table group included in the selected information on the first table group and the second table.

The control unit switches between the information on the first table group and the information on the second table group in accordance with the number of persons included in the reservation information in this manner, and thus appropriate seat assignment is performed.

The reception unit may receive a division command for designating and dividing one table included in the first table group and the second table group.

In this case, the control unit may divide the one table designated in accordance with the division command into two tables, updates the information on the first table group and the second table so as to include the two tables obtained by the division, and stores the updated information in the storage unit.

The control unit updates the information on the first table group and the information on the second table in this manner. Accordingly, it is possible to perform the division of the table, and the store can provide a service to more users.

Another aspect of the invention for accomplishing the object is an information processing device that includes a reception unit, a storage unit, a control unit, and an output unit.

The information processing device receives a reservation of a service to be provided to one or more persons at a table.

The reception unit receives reservation information for reserving reception of the service to be provided to a group including one or more persons.

The storage unit stores information on a first table group which is used for the provision of the service and is ordered, and on a second table group which is used for the provision of the service in a case where there is no room for the first table group and is constituted by tables having higher orders than tables belonging to the first table group.

The control unit associates the received reservation information with the tables of the first table group in order from the higher-order table on the basis of the reservation information, when the reception unit receives the reservation information.

In addition, the control unit cancels association of a plurality of pieces of existing reservation information in a case where the first table group does not include a table associated with the reservation information.

In addition, the control unit calculates a degree of priority for providing the service to the group for which the reservation information is reserved, with respect to each of the received plurality of pieces of reservation information, on the basis of the reservation information.

In addition, the control unit adds at least one table selected from the second table group to the first table group, and then associates the reservation information with the tables of the first table group in order from the higher-order table on a one-to-one basis, on the basis of the calculated degrees of priority.

The output unit outputs information on the table associated with the reservation information, together with the reservation information.

Still another aspect of the invention for accomplishing the object is a control method executed by an information processing device including a storage unit that stores information on a first table group which is used for provision of a service to be provided to one or more persons at a table and a second table group which is used for the provision of the service in a case where there is no room for the first table group and is constituted by tables having higher orders than tables belonging to the first table group.

The method of controlling the information processing device includes the following steps.
A step of receiving reservation information for reserving reception of the service to be provided to a group including one or more persons.
A step of associating the reservation information with the tables of the first table group in order from the higher-order table as long as one-to-one association with the tables belonging to the first table group is capable of being performed, when the reservation information is received in the step of receiving the reservation information.
A step of canceling association of a plurality of pieces of existing reservation information in a case where the first table group does not include a table associated with the reservation information.
A step of calculating a degree of priority for providing the service to the group for which the reservation information is reserved, with respect to each of the received plurality of pieces of reservation information, on the basis of the reservation information.
A step of adding at least one table selected from the second table group to the first table group and then associating the reservation information with the tables of the first table group in order from the higher-order table on a one-to-one basis, on the basis of the calculated degrees of priority.
A step of outputting information on the table associated with the reservation information, together with the reservation information.

Still another aspect of the invention for accomplishing the object is a program causing an information processing device, including a storage unit that stores information on a first table group which is used for provision of a service to be provided to one or more persons at a table and a second table group which is used for the provision of the service in a case where there is no room for the first table group and is constituted by tables having higher orders than tables belonging to the first table group, to execute the following steps.
A step of receiving reservation information, including a degree of priority for receiving the service to be provided to a group including one or more persons, for reserving the reception of the service to be provided to the group.
A step of associating the reservation information with the tables of the first table group in order from the higher-order table as long as one-to-one association with the tables belonging to the first table group is capable of being performed, when the reservation information is received in the step of receiving the reservation information.
A step of canceling association of a plurality of pieces of existing reservation information in a case where the first table group does not include a table associated with the reservation information.
A step of calculating a degree of priority for providing the service to the group for which the reservation information is reserved, with respect to each of the received plurality of pieces of reservation information, on the basis of the reservation information.
A step of adding at least one table selected from the second table group to the first table group and then associating the reservation information with the tables of the first table group in order from the higher-order table on a one-to-one basis, on the basis of the calculated degrees of priority.
A step of outputting information on the table associated with the reservation information, together with the reservation information.

As described above, according to this technique, it is possible to perform appropriate seat assignment in accordance with a reservation reception state in an information processing device that receives a reservation.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating a configuration example of a reservation reception system according to an embodiment of this technique;

FIG. 2 is a diagram illustrating information stored in a storage unit in the embodiment;

FIG. 3 is a diagram illustrating a configuration of user information in the embodiment;

FIG. 4 is a diagram illustrating a configuration of store information in the embodiment;

FIG. 5 is a diagram illustrating a configuration of table information in the embodiment;

FIG. 6 is a diagram illustrating classification of table symbols included in the table information;

FIG. 7 is a diagram illustrating a configuration of reservation information in the embodiment;

FIG. 8 is a flowchart illustrating a flow of a seat assignment process in the embodiment;

FIG. 9 is a diagram illustrating an example of a display output mode to a store terminal in the embodiment;

FIG. 10 is a flowchart illustrating a flow of processing in a case of full occupancy in the embodiment; and

FIG. 11 is a diagram illustrating classification of table symbols included in the table information.

### DETAILED DESCRIPTION OF EMBODIMENTS

Hereinafter, an embodiment according to this technique will be described with reference to the accompanying drawings. Meanwhile, a description will be given in the following order.
1. Configuration of Reservation Reception System
2. Schematic Operation of Reservation Reception System
3. Configuration of User Information
4. Configuration of Store Information
5. Configuration and Generation of Reservation Information
6. Seat Assignment Process
7. Output Process
8. Processing In Case of Full Occupancy
9. Plurality of Pieces of Table Information

### <Configuration of Reservation Reception System>

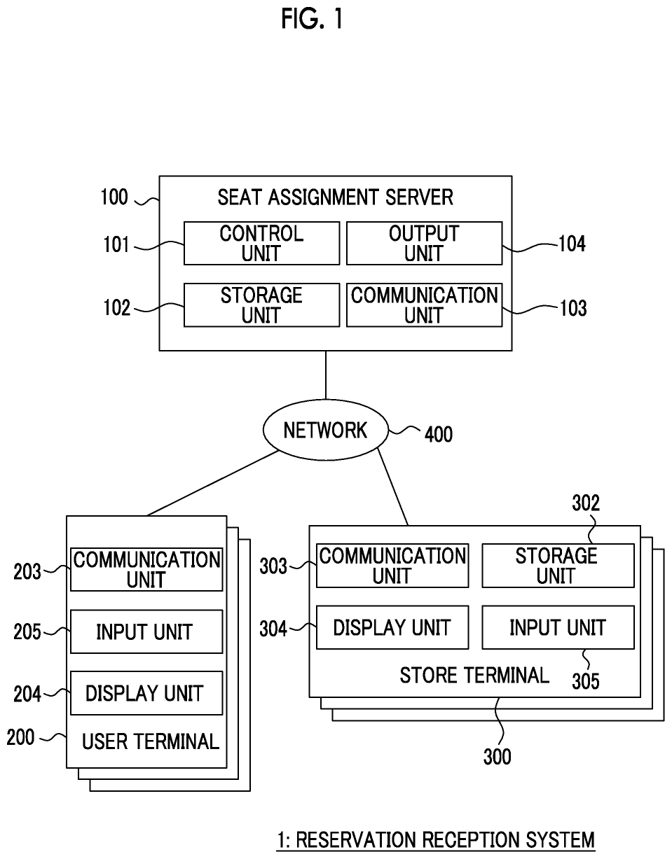

Referring to FIG. 1, a configuration example of a reservation reception system 1 according to this embodiment is illustrated. As illustrated in the drawing, the reservation reception system 1 according to this embodiment is an information communication system in which a seat assignment server 100, a user terminal 200, and a store terminal 300 are communicably connected to each other through a network 400.

The seat assignment server 100 is a server computer that controls a seat assignment process for a customer when a service is provided to the customer at a table, for example, as in a food service in each store corresponding to the store terminal 300, and includes a control unit 101, a storage unit 102, a communication unit 103, and an output unit 104. The control unit 101 can be constituted by, for example, a Central Processing Unit and the like, and can be configured as a physical device that performs the computation and control of the seat assignment server 100. The storage unit 102 can be physically constituted by a non-volatile storage device such as a hard disk drive. The communication unit 103 can be constituted by, for example, an interface device or the like which is connected to a local area network.

The seat assignment server 100 may be, for example, a restaurant information providing server that operates a portal site having information on a restaurant published therein. In this case, the seat assignment server 100 provides a restaurant information retrieval system for the user of the user terminal 200 and provides a reservation reception system of a restaurant in the portal site. Specifically, the seat assignment server 100 retrieves restaurant information matching retrieval conditions on the basis of a retrieval request received from the user terminal 200, generates a web page having retrieval results published therein, transmits the generated Web page to the user terminal 200, and receives a use reservation for a restaurant corresponding to any one restaurant information, on the basis of a user's request for a reservation.

The output unit 104 is a physical functional block having a function of outputting information processing results of the control unit 101. As a specific example, the output unit 104 may be constituted by a device, such as a display device, which is capable of performing display and output. Alternatively, the output unit 104 may be constituted by a web server that outputs information processing results to the store terminal 300 or the user terminal 200 by the communication unit 103 through the network 400.

The user terminal 200 includes a communication unit 203, a display unit 204, and an input unit 205. The user terminal 200 may be configured as a portable information communication terminal (a smart phone or the like). The communication unit 203 can be constituted by, for example, a communication device capable of performing mobile data communication. The display unit 204 has a function of displaying the information processing results of the user terminal 200, information which is output from the output unit 104 and the like of the seat assignment server 100, and the like to the user. The display unit 204 may be constituted by a liquid crystal touch panel or the like. The input unit 205 has a function of inputting an operation input of the user of the user terminal 200 to the user terminal 200. The input unit 205 may be constituted by, for example, a liquid crystal touch panel or the like.

The store terminal 300 is a terminal included in a store that provides a service at a table, for example, in a restaurant, and includes a storage unit 302, a communication unit 303, a display unit 304, and an input unit 305. The store terminal 300 may be configured as a portable information communication terminal (a smart phone or the like) or a stationary personal computer. The storage unit 302 can be physically constituted by, for example, a non-volatile storage device such as a hard disk drive or a semiconductor memory. The communication unit 303 can be constituted by, for example, an interface device or the like which is connected to a local area network. The display unit 304 has a function of displaying information processing results of the store terminal 300, information which is output from the output unit 104 of the seat assignment server 100, and the like, to the user. The display unit 304 may be constituted by a liquid crystal touch panel, or the like. The input unit 305 has a function of inputting an operation input of the user of the store terminal 300 to the store terminal 300. The input unit 305 may be constituted by, for example, a liquid crystal touch panel or the like.

The network 400 is a communication network enabling the seat assignment server 100, the user terminal 200, and the store terminal 300 to communicate with each other. The network 400 may be compositely constituted by, for example, the Internet, a mobile data communication network, and the like.

The reservation reception system 1 according to this embodiment may include a plurality of user terminals 200 being one or more user terminals, and may include a plurality of store terminals 300 being one or more store terminals.

### <Outline of Database of Reservation Reception System>

The reservation reception system 1 performs information processing for receiving a reservation for the reception of service provision from the user terminal 200 to perform seat assignment in a reserved store, and transmitting seat assignment results to the store terminal 300. The “service” as mentioned herein refers to a service to be provided at a table for which one or more seats are set. A typical example thereof is a food service in a restaurant, but is not necessarily limited to the food service.

In order to perform the information processing, store information is required to be stored in the reservation reception system 1 in advance. In addition, reservation information is required to be input to the reservation reception system 1 from the user terminal 200 or the store terminal 300. Although it is not essential, user information may be stored in the reservation reception system 1 in advance.

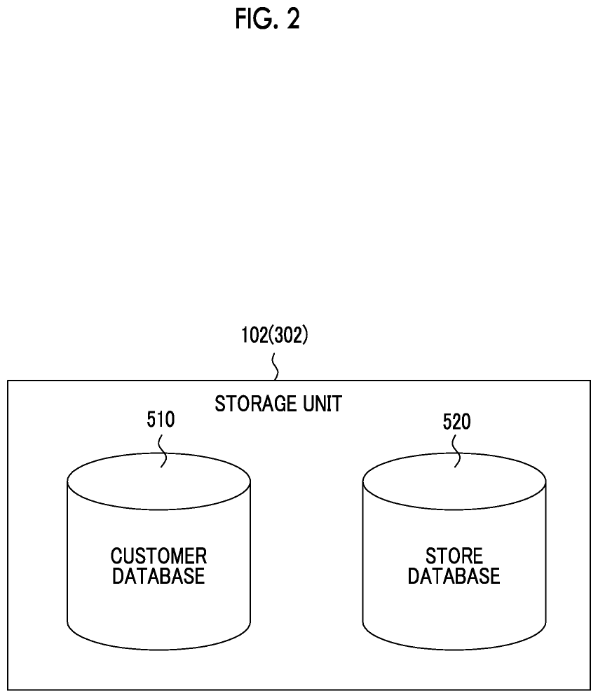

Referring to FIG. 2, information stored in the storage unit 102 and/or the storage unit 302 in this embodiment in advance is shown. As illustrated in the drawing, a customer database 510 and a store database 520 are stored. Storage destinations of these databases may be either the seat assignment server 100 or the store terminal 300. The customer database 510 stores one or more pieces of user information. The store database 520 stores one or more pieces of store information.

The user information is information on one user of the reservation reception system 1, and is information on a user who uses the user terminal 200. The store information is information on a store where the store terminal 300 is installed. Hereinafter, user information, store information, and reservation information will be described in this order.

### <Configuration of User Information>

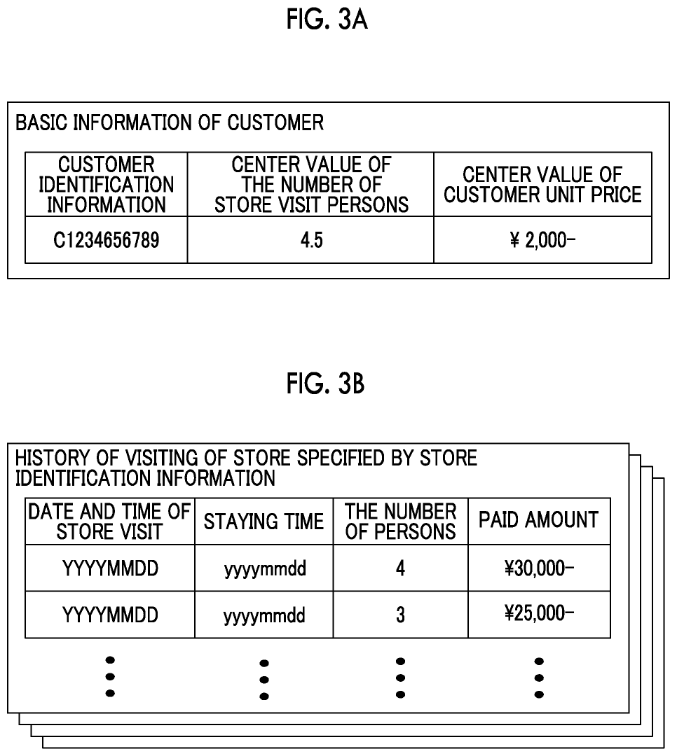

The customer database 510 can be configured as, for example, a relational database, and stores user information as illustrated in FIG. 3 for each user. Referring to FIG. 3, a conceptual diagram illustrating user information in this embodiment is shown. FIG. 3(a) illustrates “basic information on customer” in the user information, and FIG. 3(b) illustrates a “store visit history” in the user information.

Basic information on a user of the reservation reception system 1 is stored in the customer database 510 as information having customer identification information, the center value of the number of store visit persons, the center value of a customer unit price, and the like for each “user”, as illustrated in FIG. 3(a). The center value of the number of store visit persons and the center value of the customer unit price may be calculated from the store visit history.

The store visit history of the user of the reservation reception system 1 is stored in the customer database 510 as information having the date and time of store visit, a staying time, the number of store visit persons in a group, the total amount paid, and the like for each “store (or store ID)”, as illustrated in FIG. 3(b). An information table according to the store visit history includes store identification information. The store can be specified from the store identification information.

### <Configuration of Store Information>

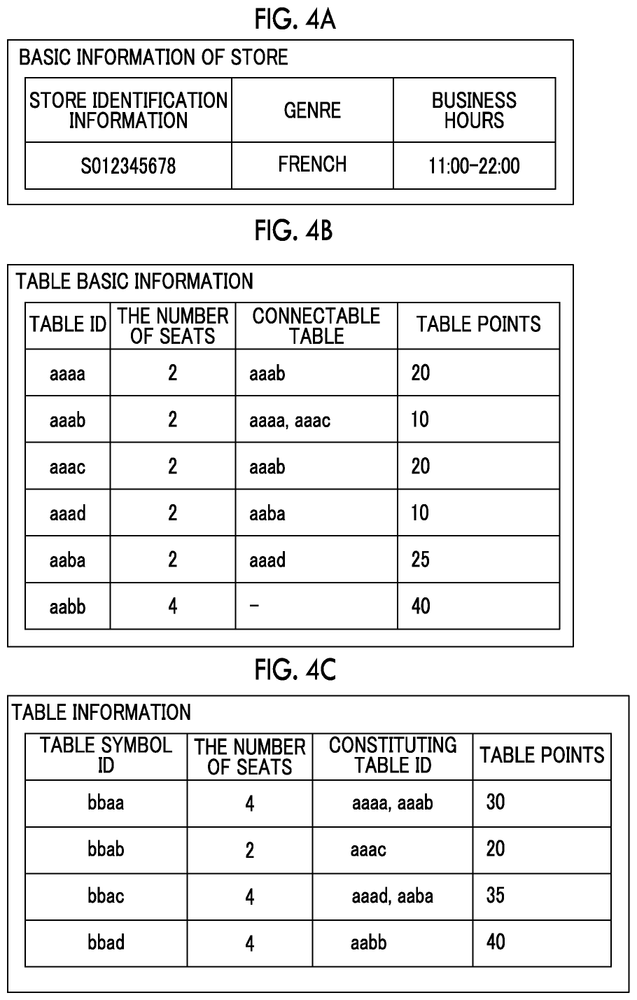

The store database 520 can also be configured as, for example, a relational database, and stores store information as illustrated in FIG. 4 for each store. Referring to FIG. 4, a conceptual diagram illustrating store information in this embodiment is shown. FIG. 4(a) illustrates “basic information on store” in the store information, FIG. 4(b) illustrates “table basic information” in the store information, and FIG. 4(c) illustrates “table information” in the store information.

The basic information on a store is stored in the store database 520 as information having store identification information, the type (genre) of service of the store, business hours, and the like for each “store”, as illustrated in FIG. 4(a). The basic information on store may additionally include positional information, address, and the like of the store. The type (genre) of service may not only be classification based on food provided by “French restaurant”, “Japanese restaurant”, and the like, but also be classification based on business categories such as “izakaya”.

Table basic information on a store is stored in the store database 520 as information having a table ID of a table included in the store, the number of seats, a connectable table, table points, and the like for each “table”, as illustrated in FIG. 4(b). Here, the table ID is information for identifying a table, and the number of seats is a maximum number of persons (a fixed number, capacity) who can take a seat at the table. The connectable table is information for designating table IDs of other tables that do not include the corresponding table. A table ID, and the like of an adjacent table are designated. The table points are an index indicating the degree of comfort of the table.

Regarding the table points, high points are given when the table is a table which is comfort to a user (store visit customer), and low points are given when the table is a table desired to be avoided in cases other than the case of congestion. For example, high points are given for a higher seat located in a deep place inside the store. Low points are given for a table located in a place close to the entrance. The giving of table points is performed by the owner or an employee of the store. The table points may be automatically given.

In the table basic information, a table for which a table ID is given is set to be a minimum unit making the division of more tables impossible (or undesirable). A table for which a table ID is given may be physically set to be one table.

The table information on a store is stored in the store database 520 as information having a table symbol ID, the number of seats, a constituting table ID, table points, and the like for each “table symbol”, as illustrated in FIG. 4(c). The table information is generated on the basis of the table basic information. The “table symbol” is a physical table constituted by one or more “tables for which a table ID is given”. The reservation reception system 1 assigns (performs seat assignment) one “table symbol” to one group visiting the store.

The “table symbol” illustrated in FIG. 4(c) is just an example of a “table symbol” which is generated using the table illustrated in FIG. 4(b). A table symbol different from that in the example illustrated in FIG. 4(c) may be generated depending on a combination of tables. In addition, a plurality of pieces of table information may be generated from the table basic information as illustrated in FIG. 4(b).

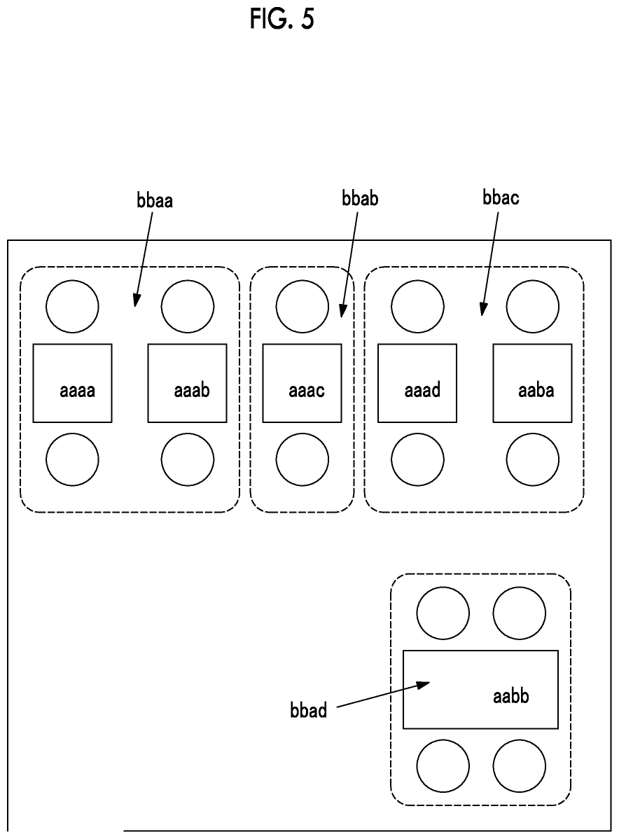

Referring to FIG. 5, an example of a store layout is illustrated. In the drawing, a rectangle indicates a table, and a circle indicates a seat. The rectangular table is a table for which a table ID is given, and is equivalent to one entry in the table basic information in FIG. 4. One or a plurality of tables surrounded by a dashed line in the drawing respectively indicate “table symbols”, and are equivalent to one entry in the table information in FIG. 4. A table ID and a table symbol ID illustrated in FIG. 5 match the table ID and the table symbol ID in FIG. 4.

The number of seats of a certain table symbol in the table information on the store can be data obtained by simply adding up the number of seats of tables constituting the table symbol, as illustrated in FIG. 4(c) and FIG. 5.

Table IDs of tables constituting a certain table symbol in the table information on the store can be data including a plurality of table IDs being one or more table IDs included in the table basic information, as illustrated in FIG. 4(c) and FIG. 5. The data is data including table IDs of adjacent tables, for example, as illustrated in FIG. 5.

Table points of a certain table symbol in the table information on the store are an index indicating the degree of comfort of the table symbol. A method of setting table points of a table symbol is not limited. For example, a value calculated by adding up table points of tables constituting the table symbol may be used. Alternatively, an arithmetic mean of the table points of the tables constituting the table symbol may be used.

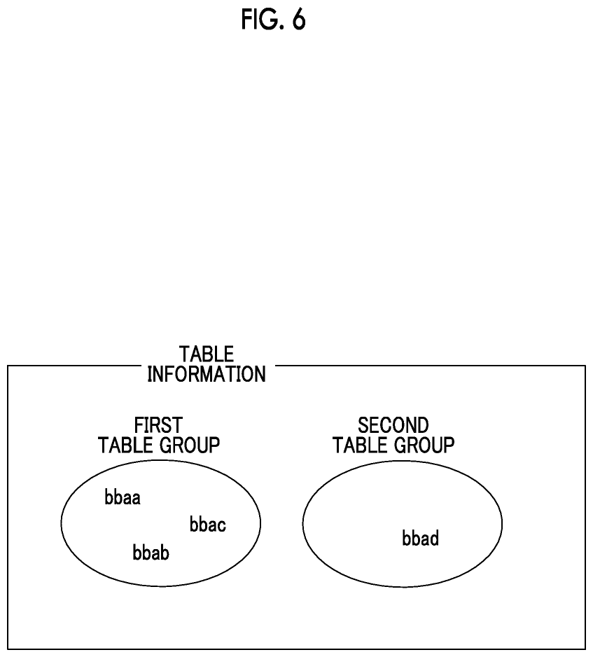

Referring to FIG. 6, a plurality of pieces of table information illustrated in FIG. 4(c) are illustrated together with classification of table symbols included in each table information. The store database 520 stores a plurality of pieces of table information being one or more pieces of table information, for each store. FIG. 6 illustrates three pieces of table information having different numbers of target persons.

Meanwhile, the number of target persons matches the number of seats of a table symbol having a minimum number of seats (“the number of seats” illustrated in FIG. 4(c)) among the table symbols included in the table information. For example, in the example of the table information in FIG. 4(c), the number of seats of a table symbol having a table symbol ID of bbab is two which is a minimum number, and thus the table information is set to be for two or less persons as in “table information 1” in FIG. 6. A table symbol for allowing up to four persons to sit is included in the table information 1, but all of the table symbols serve as table symbols for two or less persons, inclusive of the table symbol for up to four persons.

Each table information also includes information for classifying table symbols included in the table information into at least two types. One type of table symbol group is called a first table group, and the other type of table symbol group is called a second table group. Meanwhile, the table symbols may be further classified into a third table group, a fourth table group, and the like, but classification into over two types is not dealt with in this embodiment.

The first table group is a group of tables (indicating a set of tables for which a plurality of table IDs, being one or more table IDs collected as a table symbol, are given) which are guided to store visit customers, in a state where a store is not relatively congested. The second table group is a group of tables which are stocked as reserve tables in a state where a store is not relatively congested, but may be used in a state where the store is congested.

The above-described store information is stored in the store database 520 for each store. Meanwhile, the table information on the store may be information which is dynamically generated.

### <Configuration and Generation of Reservation Information>

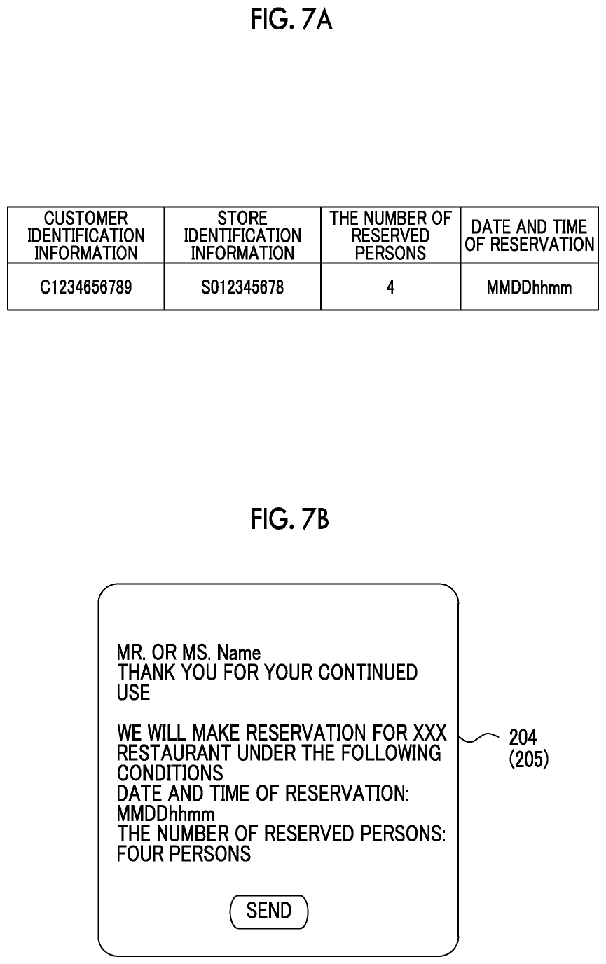

Referring to FIG. 7(a), an example of a configuration of reservation information is illustrated. As illustrated in the drawing, the reservation information is information including at least customer identification information, the number of reserved persons, the date and time of reservation, and store identification information. Referring to FIG. 7(b), an example of a user interface screen displayed on the display unit 204 of the user terminal 200 is illustrated.

The user terminal 200 prompts the user of the user terminal 200 to input the number of reserved persons and the date and time of reservation by using a screen as illustrated in FIG. 7(b), and transmits customer identification information and store identification information together to the seat assignment server 100. The screen may be executed on a browser of the user terminal 200 as a Web page generated by the seat assignment server 100, or may be executed on an application for store searching and reservation which is installed in the user terminal 200. Regarding the embedding of the customer identification information and the store identification information into a dialogue as illustrated in FIG. 7(b) and the generation of the reservation information as illustrated in FIG. 7(a) on the basis of information which is input from the dialogue, a Web application technique which is well known by those skilled in the art can be used.

### <Seat Assignment Process>

When the seat assignment server 100 receives the reservation information which is transmitted from the user terminal 200, a reservation process and a seat assignment process are executed by the control unit 101 of the seat assignment server 100. Regarding a reservation process for inputting a reservation of a user specified by the customer identification information included in the reservation information into a store specified by the store identification information included in the reservation information, a technique well known by those skilled in the art can be used.

Hereinafter, the seat assignment process executed by the seat assignment server 100 after the reservation process (or during the reservation process) will be described. There are various methods for a specific flow of the seat assignment process, and one example of the methods will be described below.

In the seat assignment process of this embodiment, first, the control unit 101 checks the number of persons included in reservation information when the reception unit 103 receives the reservation information. Next, the control unit 101 selects any one table information from among a plurality of pieces of table information in accordance with the number of persons included in the reservation information. For example, in a case of a reservation for four persons, “table information 2” is selected. As described above with reference to FIG. 6, the store database 520 stores a plurality of pieces of table information having different numbers of target persons.

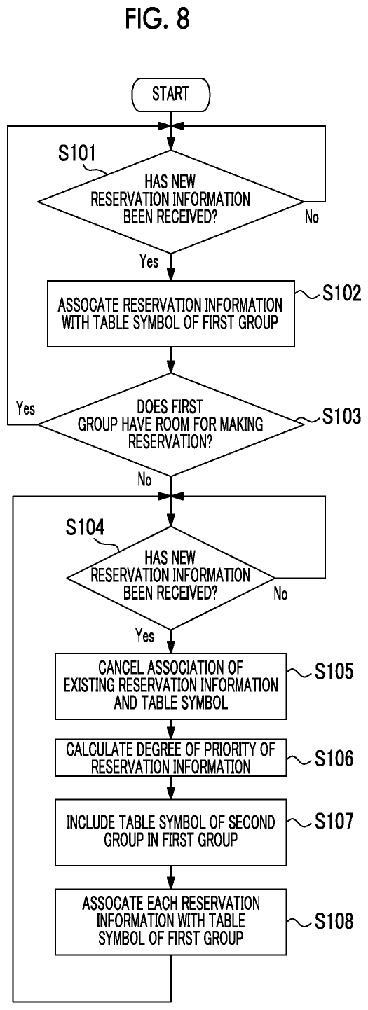

Appropriate seat assignment is performed by switching table information in accordance with the number of persons included in the reservation information by the control unit. Hereinafter, a seat assignment process for performing seat assignment of reservation information with respect to table symbols included in one table information will be described with reference to FIG. 8, but the same seat assignment process is performed for other pieces of table information.

Referring to FIG. 8, an example of a flow of the seat assignment process is illustrated by a flowchart. As illustrated in the drawing, when the control unit 101 determines that the communication unit 103 of the seat assignment server 100 has received reservation information (S101, Yes), the control unit 101 associates the reservation information with one of the table symbols belonging to the first table group (S102).

In S102, the control unit 101 associates a table symbol having the highest table points, among table symbols which are not associated with any reservation information among the table symbols belonging to the first table group, with the received reservation information. The associated table symbol regarded as a table “having a reservation embedded thereinto”.

Next, the control unit 101 determines whether or not an unassociated table symbol, capable of taking a reservation for the first table group, is present (S103). A repeated process from S101 to S103 is continued until a table symbol, which is not associated with the first table group, completely disappears. That is, when there is no room for taking a reservation for the first table group (S103, No), the repeated process from S101 to S103 is omitted.

After S104, reservation information is associated with all of the table symbols belonging to the first table group. Similarly to S101, when the control unit 101 determines that the communication unit 103 of the seat assignment server 100 has received the reservation information (S104, Yes), the control unit 101 once cancels the association of the existing reservation information and the table symbol (S105).

Next, the control unit 101 calculates the degree of priority of the reservation information (S106). The “degree of priority of reservation information” as mentioned herein is calculated on the basis of at least one or more selected from among the number of reserved persons, a predicted customer unit price, the reservation time, a predicted staying time, and the past service use mode. The number of reserved persons, the predicted customer unit price, the reservation time, the predicted staying time, and the past service use mode are the reservation information itself, or are determined or calculated by the control unit 101 on the basis of the customer identification information and the store identification information included in the reservation information.

The expectation of the customer unit price and the like which is executed by the control unit 101 can be executed by various methods, such as a method of performing machine learning having a teacher, by using the past use history of the user or use histories of all users including the user.

As a specific example of the past service use mode, for example, the property of a customer such as “being or not being a patron” is also included. In addition, information such as use frequency per month is also included. Information regarding the past service use mode such as properties of exceptional customers and use frequency may be stored in the customer database 510 by being included in “basic information on a customer” illustrated in FIG. 3(a).

The calculation of the degree of priority which is performed in S106 may be performed with respect to only reservation information which has not yet been calculated.

Next, the control unit 101 changes classification so that one of the table symbols belonging to the second table group belongs to the first table group (S107). In this case, the control unit 101 may select a table symbol having the lowest table points from among the table symbols belonging to the second table group to change classification so that the selected table symbol belongs to the first table group.

Next, the control unit 101 associates the reservation information of which the association is canceled in S105, with the table symbols belonging to the first table group which are increased in number in S107 (S108). In this case, the control unit 101 performs association with table symbol having higher table points in order from the table symbol having a high degree of priority of the reservation information which is calculated in S106.

The control unit 101 cancels the association of the reservation information and the table symbol in a case where a reservation is canceled or the provision of a service is terminated due to the arrival of reservation time. Although not shown in FIG. 8, the control unit 101 executes a process of canceling the association of the reservation information and the table symbol when such a case occurs at any point in time during a loop from S104 to S108.

### <Output Process>

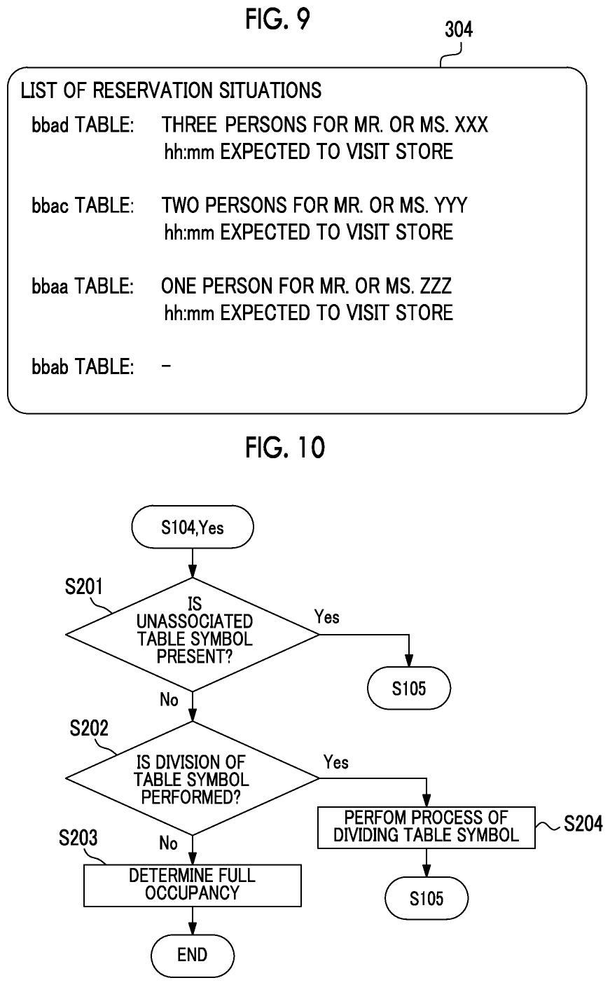

The output unit 104 frequently outputs the association of the table symbol and the reservation information. Therefore, the output unit 104 frequently outputs changed association even in a case where the association of the table symbol and the reservation information is canceled due to the occurrence of reservation cancellation or even in a case where the association of the table symbol and the reservation information is changed due to the execution of the processing from S105 to S108 in FIG. 8. An output destination is preferably the display unit 304 of the store terminal 300. FIG. 9 illustrates an example of a mode of display and output to the display unit 304 by the output unit 104.

### <Processing In Case of Full Occupancy>

When the reception unit 103 has received new reservation information in S104 of FIG. 8, the control unit 101 determines full occupancy in case where the total number of pieces of reservation information received is the same as the number of table symbols which is obtained by adding the number of table symbols belonging to the first table group and the number of table symbols belonging to the second table group. For example, as illustrated in FIG. 6, in a case where the number of table symbols which is obtained by adding the number of table symbols belonging to the first table group and the number of table symbols belonging to the second table group is four, the control unit 101 determines full occupancy in case where a total of four pieces of reservation information have been received in S104.

Referring to FIG. 10, a processing procedure in a case of full occupancy is shown by a flowchart. The procedure shown in FIG. 10 is inserted between S104 and S105 of FIG. 8. As illustrated in the drawing, the control unit 101 first determines whether or not an associated table symbol is present, with reference to the table information (S201). In a case where an associated table symbol is present (S201, Yes), the control unit terminates this processing and proceeds to S105.

In a case where it is determined that an associated table symbol is not present (S201, No), the control unit 101 determines whether to perform the division of table symbols (S202). As illustrated in FIG. 4(c), there is a table symbol constituted by a plurality of physical tables (tables for which a table ID is given). As shown in the example of FIG. 4(c), the table symbol corresponds to, for example, the table symbols having table symbol IDs of bbaa and bbac in the drawing. The control unit 101 determines whether to perform the division of table symbols in S202. This determination is performed by determining whether or not the table information includes a table symbol for which a flag indicating dividableness is given, by the control unit 101. The giving of the flag is performed in advance by the store terminal 300.

In a case where it is determined that the division of table symbols is not performed (S202, No), the control unit 101 determines full occupancy (S203). On the other hand, in a case where it is determined that the division of table symbols is performed (S202, Yes), the control unit 101 executes the process of dividing table symbols (S204), and then proceeds to S105.

The process of dividing table symbols is performed by dividing a table symbol to be divided into two table symbols by the control unit 101 so that each of the table symbols obtained by the division has at least one table ID, and giving a table symbol ID to each of the table symbols obtained by the division. Regarding the table symbol to be divided, one table symbol is selected from among the table symbols for which a flag indicating dividableness is given to the table information.

The table symbol to be divided may be configured to be designated from the store terminal 300. In this case, the reception unit 103 receives a division command for designating and dividing one table symbol in the table information. When the reception unit 103 receives the division command, the control unit 101 divides one table symbol designated in accordance with the division command into two table symbols, and updates the table information so as to include the two table symbols obtained by the division. The updated table information is stored in the store database 520.

### MODIFICATION EXAMPLE

The invention is not limited to the above-described embodiment, and can be modified in various ways without departing from the scope of this disclosure.

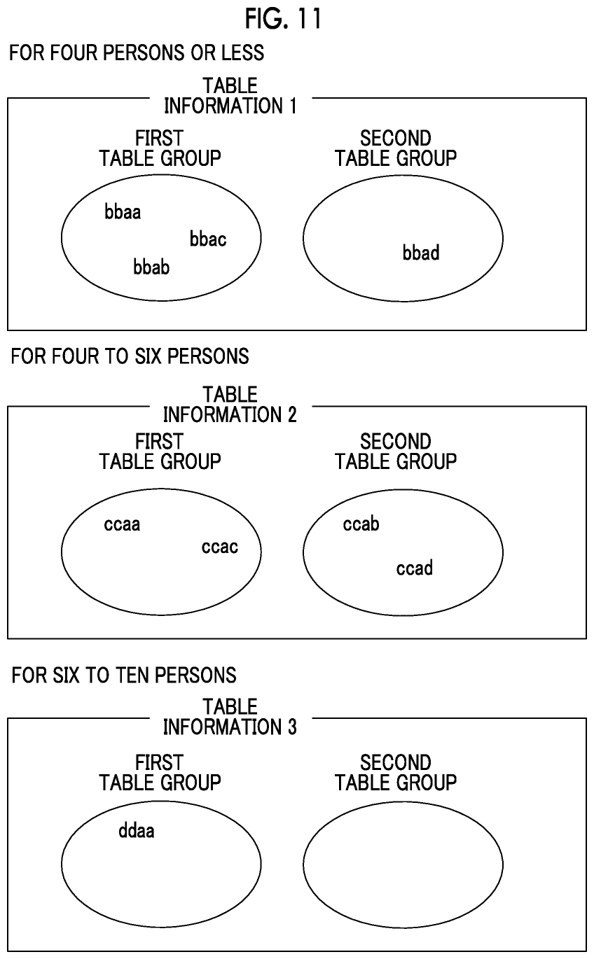

In the above-described embodiment, a description has been given of an example of a case where the number of pieces of table information is one as illustrated in FIG. 6, but the invention is not limited thereto. In other embodiments, a configuration may be adopted such that a plurality of pieces of table information are provided as illustrated in FIG. 11. In this case, a configuration may also be adopted such that each table symbol is classified into different pieces of table information corresponding to the size of a store visit group, as illustrated in FIG. 11. That is, the storage unit 102 stores a plurality of pieces of table information (information on the first table group and the second table group). The plurality of pieces of table information differ from each other in a maximum number of usable persons.

In the reservation reception system 1, when the communication unit 103 receives reservation information, the control unit 101 selects any one table information from among the plurality of pieces of table information as illustrated in FIG. 11, in accordance with information on the number of persons of a group included in the reservation information. Next, the process described with reference to FIG. 8 will be performed by using the selected table information. With such a configuration, it is possible to efficiently make a reservation for seat assignment with respect to various groups in terms of the number of store visit persons. In other words, it is possible to perform appropriate seat assignment.

In the above-described embodiment, a description has been given of a configuration in which the reservation reception system 1 includes the seat assignment server 100, and the control unit 101 of the seat assignment server executes the above-described processes such as a seat assignment process, an output process, and a process in a case of full occupancy. However, the role taken by the control unit 101 in the above-described embodiment may be taken by the control unit of the store terminal 300. In this case, the seat assignment server 100 in the above-described embodiment can be omitted, and a configuration can be adopted in which each store terminal 300 performs a seat assignment process. There is an effect that the independence of each store terminal 300 is increased. Meanwhile, in this case, a configuration may be adopted in which each store terminal 300 includes the customer database 510.

### MODIFICATION EXAMPLE 2

In the above-described embodiment, as an example of a seat assignment process, a description has been given of an example in which the control unit 101 associates reservation information with a table symbol having higher table points on a first-come-first-served basis as long as a reservation can be made for the first table group (FIGS. 8, S101 to S103). However, as a modification of the example, the control unit 101 may associate reservation information with a table symbol having high table points on the basis of the degree of priority of the reservation information, instead of simply associating the reservation information with a table symbol having high table points on a first-come-first-served basis, when a reservation can be made for the first table group.

In this case, an example of the degree of priority of the reservation information is the degree of priority which is calculated on the basis of at least one selected from among, for example, the number of persons, an expected customer unit price, reservation time, an expected staying time, and the past service use mode which are related to the reservation information, as described in the process regarding S106 in FIG. 8. Examples of the past service use mode as mentioned herein include information indicating “being or not being a patron or a regular customer” and service use frequency, as described in the process regarding S106. That is, the degree of priority of the reservation information is calculated by the control unit 101 on the basis of the reservation information.

Therefore, in this case, the control unit 101 provisionally associates the received reservation information with a table symbol having high table points on the basis of the reservation information (in more detail, on the basis of the degree of priority which is calculated on the basis of the reservation information), as long as a reservation can be made for the first table group.

It is needless to say that all of the configurations disclosed in the above-described embodiment are incorporated in this modification example, with regard to configurations of portions other than the above-described configurations. According to this modification example, it is possible to improve Customer Satisfaction (CS) by guiding a part to be provided with CS to a seat having good conditions on the basis of reservation information, as long as a reservation can be made for the first table group, that is, even in a case where there are enough remaining seats.

### MODIFICATION EXAMPLE 3

Reservation information will be supplementarily described.

In the above-described embodiment, FIG. 7 has been illustrated as an example of reservation information, and the reservation information is information including at least customer identification information, the number of reserved persons, the date and time of reservation, and store identification information. In addition, as an example of the generation of the reservation information, a description has been given of an example in which the reservation information is generated through a browser or an application which is executed on the user terminal 200. However, the generation of the reservation information is not limited to the example described in the above-described embodiment. The store terminal 300 may generate the reservation information.

For example, a walk-in customer may install a store terminal 300, which is operated by the walk-in customer, at the entrance of a store and may input the number of persons and customer identification information. In this case, the store terminal 300 automatically supplements the date and time of reservation with the present time and supplements store identification information with identification information of the store, and transmits the reservation information to the seat assignment server 100. Meanwhile, in this case, for example, a tablet terminal may be adopted as the store terminal 300. In addition, the walk-in customer's input of the customer identification information to the store terminal 300 may be performed using various techniques, such as customer identification through face authentication and the reading of a contactless IC card including information for specifying customer identification information, which are known by those skilled in the art.

In addition, for example, an employee manually inputs some pieces of information such as the number of walk-in customers to the store terminal 300, and thus information necessary for the generation of reservation information by the store terminal 300 may be supplemented.

Meanwhile, in this manner, in a case where the reservation information is generated at the same time as the visiting of the walk-in customer, the date and time of reservation immediately arrives, and thus it is preferable that the seat assignment process of FIG. 8 is rapidly executed.

In this modification example, a description has been given of a case where reservation information is generated by the store terminal 300, instead of a case where reservation information is generated by the user terminal 200 in the above-described embodiment. In this manner, the “reservation information” also includes the concept of a table use request for rapidly determining a seat to be used by a walk-in customer. In other words, the “reservation information” also includes information for reserving the reception of service provision with little gap, as in the case of a walk-in customer.

### MODIFICATION EXAMPLE 4

In the above-described embodiment and modification examples, it is assumed that the number of tables prepared for reserved customers is two or more in a situation before a reservation reception state is changed. These descriptions do not intend to exclude a case where the number of tables is one, and the operational effects disclosed in the above-described embodiment and modification examples are also obtained in a case where the number of tables is one. Meanwhile, the same is true of a case where the number of tables prepared for reserved customers is one in a situation after a reservation reception state is changed.

### DESCRIPTION OF REFERENCE NUMERALS

1: reservation reception system
100: seat assignment server
101: control unit
102: storage unit
103: communication unit
104: output unit
200: user terminal
203: communication unit
204: display unit
205: input unit
300: store terminal
302: storage unit
303: communication unit
304: display unit
305: input unit
510: customer database
520: store database

1. An information processing device configured to receive a reservation of a service to be provided to one or more persons at a table, the information processing device comprising:
a reception unit configured to receive reservation information for reserving reception of the service to be provided to a group including one or more persons;
a storage unit configured to store information on a first table group which is used for the provision of the service and is ordered, and on a second table group which is used for the provision of the service in a case where there is no room for the first table group and is constituted by tables having higher orders than tables belonging to the first table group;
a control unit configured to
associate the reservation information with the tables of the first table group in order from the higher-order table as long as one-to-one association with the tables belonging to the first table group is capable of being performed, when the reservation information is received by the reception unit,
cancel association of a plurality of pieces of existing reservation information in a case where the first table group does not include a table associated with the reservation information,
calculate a degree of priority for providing the service to the group for which the reservation information is reserved, with respect to each of the received plurality of pieces of reservation information, on the basis of the reservation information,
add at least one table selected from the second table group to the first table group, and
associate the reservation information with the tables of the first table group in order from the higher-order table on a one-to-one basis, on the basis of the calculated degrees of priority; and
an output unit configured to output information on the table associated with the reservation information, together with the reservation information.

2. The information processing device according to claim 1,
wherein the control unit is configured to calculate the degree of priority included in the reservation information, on the basis of at least one or more selected from the number of persons, a customer unit price, reservation time, a staying time, and a past service use mode which are acquired from the reservation information.

3. The information processing device according to claim 1,
wherein the control unit is configured to determine full occupancy in a case where the reception unit receives the reservation information of a group having the same number of tables as the number of tables obtained by adding the number of tables of the first table group and the number of tables of the second table group.

4. The information processing device according to claim 1,
wherein the storage unit is configured to store a plurality of pieces of information on the first table group and the second table group which have different maximum numbers of usable persons,
wherein the reception unit is configured to receive the reservation information including the number of persons of the group, and
wherein the control unit is configured to select any one information from among the plurality of pieces of information on the first table group and the second table group in accordance with the number of persons included in the reservation information received by the reception unit, and configured to associate the received reservation information with any one table of the first table group included in the selected information on the first table group and the second table group.

5. The information processing device according to claim 1,
wherein the reception unit is configured to receive a division command for designating and dividing one table included in the first table group and the second table group, and
wherein the control unit is configured to
divide the one table designated in accordance with the division command into two tables,
update the information on the first table group and the second table group so as to include the two tables obtained by the division, and
store the updated information in the storage unit.

6. An information processing device configured to receive a reservation of a service to be provided to one or more persons at a table, the information processing device comprising:
a reception unit configured to receive reservation information for reserving reception of the service to be provided to a group including one or more persons;
a storage unit configured to store information on a first table group which is used for the provision of the service and is ordered, and on a second table group which is used for the provision of the service in a case where there is no room for the first table group and is constituted by tables having higher orders than tables belonging to the first table group;
a control unit configured to
associate the received reservation information with the tables of the first table group in order from the higher-order table on the basis of the reservation information, when the reception unit receives the reservation information,
cancel association of a plurality of pieces of existing reservation information in a case where the first table group does not include a table associated with the reservation information,
calculate a degree of priority for providing the service to the group for which the reservation information is reserved, with respect to each of the received plurality of pieces of reservation information, on the basis of the reservation information,
add at least one table selected from the second table group to the first table group, and
associates the reservation information with the tables of the first table group in order from the higher-order table on a one-to-one basis, on the basis of the calculated degrees of priority; and
an output unit configured to output information on the table associated with the reservation information, together with the reservation information.

7. A control method executed by an information processing device, the information processing device—including a storage unit configured to store information on a first table group which is used for provision of a service to be provided to one or more persons at a table and a second table group which is used for the provision of the service in a case where there is no room for the first table group and is constituted by tables having higher orders than tables belonging to the first table group, the control method comprising:
receiving reservation information for reserving reception of the service to be provided to a group including one or more persons;
associating the reservation information with the tables of the first table group in order from the higher-order table as long as one-to-one association with the tables belonging to the first table group is capable of being performed, when the reservation information is received in the step of receiving the reservation information;
canceling association of a plurality of pieces of existing reservation information in a case where the first table group does not include a table associated with the reservation information;
calculating a degree of priority for providing the service to the group for which the reservation information is reserved, with respect to each of the received plurality of pieces of reservation information, on the basis of the reservation information;
adding at least one table selected from the second table group to the first table group and then associating the reservation information with the tables of the first table group in order from the higher-order table on a one-to-one basis, on the basis of the calculated degrees of priority; and
outputting information on the table associated with the reservation information, together with the reservation information.

8. non-transitory computer-readable storage medium storing a control program causing an information processing device, the information processing device including a storage unit configured to store information on a first table group which is used for provision of a service to be provided to one or more persons at a table and a second table group which is used for the provision of the service in a case where there is no room for the first table group and is constituted by tables having higher orders than tables belonging to the first table group, to execute steps of:
receiving reservation information, for receiving the service to be provided to a group including one or more persons, for reserving the reception of the service to be provided to the group;
associating the reservation information with the tables of the first table group in order from the higher-order table as long as one-to-one association with the tables belonging to the first table group is capable of being performed, when the reservation information is received in the step of receiving the reservation information;
canceling association of a plurality of pieces of existing reservation information in a case where the first table group does not include a table associated with the reservation information;
calculating a degree of priority for providing the service to the group for which the reservation information is reserved, with respect to each of the received plurality of pieces of reservation information, on the basis of the reservation information;
adding at least one table selected from the second table group to the first table group and then associating the reservation information with the tables of the first table group in order from the higher-order table on a one-to-one basis, on the basis of the calculated degrees of priority; and
outputting information on the table associated with the reservation information, together with the reservation information.

9. A control method executed by an information processing device, the information processing device including a storage unit configured to store information on a first table group which is used for provision of a service to be provided to one or more persons at a table and a second table group which is used for the provision of the service in a case where there is no room for the first table group and is constituted by tables having higher orders than tables belonging to the first table group, the control method comprising:
receiving reservation information for reserving reception of the service to be provided to a group including one or more persons;
associating the received reservation information with the tables of the first table group in order from the higher-order table on the basis of the reservation information, when the reservation information is received in the step of receiving the reservation information;
canceling association of a plurality of pieces of existing reservation information in a case where the first table group does not include a table associated with the reservation information;
calculating a degree of priority for providing the service to the group for which the reservation information is reserved, with respect to each of the received plurality of pieces of reservation information, on the basis of the reservation information;
adding at least one table selected from the second table group to the first table group and then associating the reservation information with the tables of the first table group in order from the higher-order table on a one-to-one basis, on the basis of the calculated degrees of priority; and
outputting information on the table associated with the reservation information, together with the reservation information.

10. A non-transitory computer-readable storage medium storing a control program causing an information processing device, the information processing device including a storage unit configured to store information on a first table group which is used for provision of a service to be provided to one or more persons at a table and a second table group which is used for the provision of the service in a case where there is no room for the first table group and is constituted by tables having higher orders than tables belonging to the first table group, to execute steps of:
receiving reservation information, for receiving the service to be provided to a group including one or more persons, for reserving the reception of the service to be provided to the group;
associating the received reservation information with the tables of the first table group in order from the higher-order table on the basis of the reservation information, when the reservation information is received in the step of receiving the reservation information;
canceling association of a plurality of pieces of existing reservation information in a case where the first table group does not include a table associated with the reservation information;
calculating a degree of priority for providing the service to the group for which the reservation information is reserved, with respect to each of the received plurality of pieces of reservation information, on the basis of the reservation information;
adding at least one table selected from the second table group to the first table group and then associating the reservation information with the tables of the first table group in order from the higher-order table on a one-to-one basis, on the basis of the calculated degrees of priority; and
outputting information on the table associated with the reservation information, together with the reservation information.
